(19) United States
(12) Patent Application Publication
(10) Pub. No.: US 2016/0178024 A1
(43) Pub. Date: Jun. 23, 2016

(54) PROTECTION TUBE FOR COIL SPRING OF CAR SUSPENSION, METHOD FOR MANUFACTURING COIL SPRING OF CAR SUSPENSION, AND COIL SPRING OF CAR SUSPENSION MANUFACTURED USING THE SAME

(71) Applicants: SUNG RHIM TECH & TRADE CO., LTD., Daegu (KR); SAM MOK KANG UP CO., LTD., Gyeonggi-do (KR)

(72) Inventor: Yong Bok LEE, Gyeonggi-do (KR)

(21) Appl. No.: 14/574,301

(22) Filed: Dec. 17, 2014

(51) Int. Cl. F16F 1/02; B29C 65/64; B60G 11/14; C08J 7/02; B29C 45/00; B29C 45/26

(52) U.S. Cl. CPC F16F 1/024; B29C 45/0001; B29C 45/261; B60G 11/14; C08J 7/02; B29C 65/64; B29K 2075/00

(57) ABSTRACT

A protection tube for a coil spring of a car suspension that is tapered is provided where the inner diameter of the protection tube is larger than the inner diameter of the protection tube, the protection tube has a spiral groove or protrusion formed along the outer peripheral surface thereof. A method for manufacturing a coil spring of a car suspension includes the steps of: impregnating a protection tube for a coil spring of a car suspension into a composition comprising 45 to 65 wt % of a swelling promotion solvent, 30 to 54 wt % of a swelling control solvent, and 0 to 5 wt % of a lubricating additive to obtain the swelled protection tube; fitting the swelled protection tube to the coil spring of the car suspension to obtain an assembled body; and drying the assembled body in the air.

### BACKGROUND

The present invention relates to a protection tube for a coil spring of a car suspension, and more particularly, to a polyurethane protection tube for a coil spring of a car suspension which is coated on the coil spring of the car suspension to protect the coil spring.

In case of existing vehicle suspension, leaf springs or coil springs are mounted to absorb the shocks caused during the vehicle is driven, thus protecting the vehicle's body and making passengers feel comfortable while the vehicle is being driven. In case of the car suspension, particularly, the coil springs are mounted to protect the car's body from external shocks and to make the passengers feel comfortable while the car is being driven.

When the car is driven on a non-paved road, rough road, or puddle full of rainwater, however, large shocks are applied to the coil springs, and at this time, friction is momentarily generated between the coil springs, thus causing big noise on the coil springs. Further, the coated surfaces of the coil springs are damaged due to the friction caused by the foreign materials such as soil, sand, gravel and the like generated from the road surface, thus generating rust and corrosion on the coil springs due to oxidation reaction in the air and calcium chloride and further causing breakage and cracks on the coil springs. So as to avoid the above-mentioned problems, accordingly, protection tubes have been coupled to the coil springs of the car suspension.

In this case, however, the protection tube has an incised portion exposed to the outside, into which foreign materials may be invaded. That is, the foreign materials such as soil, sand, gravel and the like generated from the road while the car is being driven are invaded into the incised portion of the protection tube, thus reducing the elasticity of the protection tube, deforming the shape of the protection tube, and even breaking the protection tube. As a result, the conventional protection tube may have bad performance, and accordingly, there is a definite need for the development of a new protection tube capable of overcoming the above-mentioned problems.

### SUMMARY OF THE INVENTION

Accordingly, the present invention has been made in view of the above-mentioned problems occurring in the prior art, and it is an object of the present invention to provide a protection tube for a coil spring of a car suspension that is tapered so that unlike the existing protection tube for the coil spring of the car suspension having an incised portion formed thereon, it can prevent the invasion of foreign materials into the incised portion, thus improving the durability and conducting easy molding and mounting.

It is another object of the present invention to provide a method for manufacturing a coil spring of a car suspension that is carried out in a simple manner, thus reducing the manufacturing cost.

It is yet another object of the present invention to provide a coil spring of a car suspension that is made using a method for manufacturing a coil spring of a car suspension.

To accomplish the above-mentioned objects, according to a first aspect of the present invention, there is provided a protection tube for a coil spring of a car suspension that is tapered wherein the inner diameter of the protection tube on one side end portion thereof is larger than the inner diameter of the protection tube on the other side end portion thereof and the protection tube has a spiral groove or protrusion formed along the outer peripheral surface thereof.

According to the present invention, preferably, a distance between the adjacent spiral grooves or protrusions is in the range of 10 to 30 mm.

According to the present invention, preferably, a depth of the spiral groove or a height of the spiral protrusion is in the range of 0.4 to 1 mm.

According to the present invention, preferably, the ratio of the depth of the spiral groove or the height of the spiral protrusion to the thickness of the protection tube is in the range between 0.2:1 and 0.4:1.

According to the present invention, preferably, the protection tube includes one or more selected from the group consisting of polyester resin containing polycaprolactone and polyadipate and polyether resin containing polytetramethylene glycol, polyethylene glycol and polypropylene glycol.

To accomplish the above-mentioned objects, according to a second aspect of the present invention, there is provided a method for manufacturing a coil spring of a car suspension including the steps of: impregnating a protection tube for the coil spring of the car suspension into a composition including 45 to 65 wt % of a swelling promotion solvent, 30 to 54 wt % of a swelling control solvent, and 0 to 5 wt % of a lubricating additive to obtain the swelled protection tube for the coil spring of the car suspension; fitting the swelled protection tube for the coil spring of the car suspension to the coil spring of the car suspension to obtain an assembled body; and drying the assembled body in the air.

According to the present invention, preferably, the swelling promotion solvent includes one or more selected from the group consisting of acetone, tetrahydrofuran, chloroform, ethyl chloride, trichloroethylene, tetrachloroethylene, methyl chloride, methylene chloride, dichloroethane, chlorobenzene, benzene, toluene, methyl acrylate, vinyl acetate, ethyl acetate, di acetone alcohol, dibutyl phthalate, methylethylketone, ethylhexanol and methyl acetate.

According to the present invention, preferably, the swelling control solvent includes one or more selected from the group consisting of nucleic acid, heptane, octane, cyclohexane, isopropyl alcohol, methanol and distilled water.

According to the present invention, preferably, the lubricating additive includes one or more selected from the group consisting of solid paraffin, liquid paraffin, ethylene glycol, propylene glycol, silicone oil and soybean oil.

To accomplish the above-mentioned objects, according to a third aspect of the present invention, there is provided a coil spring of a car suspension that is made using the method for manufacturing the coil spring of the car suspension according to the present invention.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a protection tube for a coil spring of a car suspension according to a first embodiment of the present invention;

FIG. 2 is an enlarged view showing the protection tube for a coil spring of a car suspension according to the first embodiment of the present invention;

FIG. 3 is a perspective view showing the state wherein the protection tube according to the first embodiment of the present invention is coupled to the coil spring of the car suspension; and

FIG. 4 is an enlarged view showing a protection tube for a coil spring of a car suspension according to a second embodiment of the present invention.

### DETAILED DESCRIPTION OF THE PREFERRED EMBODIMENTS

Hereinafter, an explanation on a protection tube for a coil spring of a car suspension configuration, a method for manufacturing a coil spring of a car suspension, and a coil spring of a car suspension manufactured using the method according to the present invention will be in detail given with reference to the attached drawing.

The term “inward direction” used in the present invention means the direction closing to the center of a protection tube, and the term “outward direction” used in the present invention means the direction distant from the center of the protection tube.

In the same manner as above, the term “inner diameter” used in the present invention means the inner diameter of the protection tube, and the term “outer diameter” used in the present invention means the outer diameter of the protection tube. The term “thickness” used in the present invention means an absolute value of the difference between the inner diameter and the outer diameter.

The term “inner peripheral surface” used in the present invention means the inner peripheral surface of the protection tube, and the term “outer peripheral surface” used in the present invention means the outer peripheral surface of the protection tube.

The term “polyurethane resin” used in the present invention means polymer compounds containing urethane bond. The polymer compounds may contain urea bond, amide bond, biuret bond, allophanate bond, ether bond, or ester bond, but they are not limited thereto. In more detail, the polyurethane resin may include one or more selected from the group consisting of polyester resin containing polycaprolactone and polyadipate and polyether resin containing polytetramethylene glycol, polyethylene glycol and polypropylene glycol.

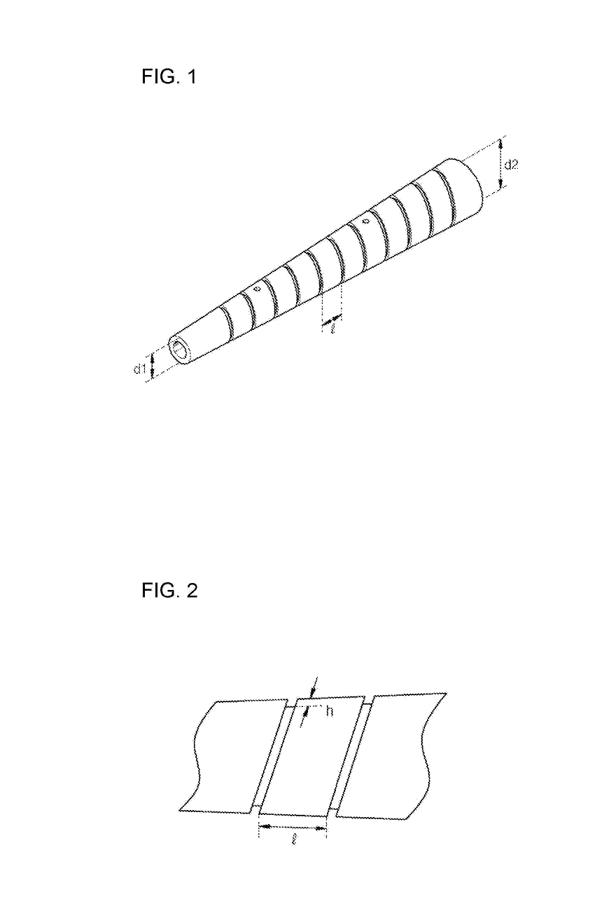

FIG. 1 is a perspective view showing a protection tube for a coil spring of a car suspension according to a first embodiment of the present invention. Referring to FIG. 1, a protection tube for a coil spring of a car suspension according to the present invention is tapered wherein the inner diameter d2 of the protection tube on one side end portion thereof is larger than the inner diameter d1 of the protection tube on the other side end portion thereof, and the protection tube has a spiral groove formed along the outer peripheral surface thereof.

The inner diameter d2 of the protection tube on one side end portion thereof is larger than the inner diameter d1 of the protection tube on the other side end portion thereof, and accordingly, when the protection tube dries and shrinks after has been swollen and fitted to the coil spring of the car suspension, it can be fixed to a desired position. That is, if the swelled protection tube is located on the coil spring of the car suspension around the smaller inner diameter d1 thereof, the protection tube after drying can be fixed thereto, without having any deviation from the reference position. When the protection tube is made especially by means of injection molding, further, the protection tube can be easily released from a mold.

The ratio of the inner diameter d2 of the protection tube on one side end portion thereof to the inner diameter d1 of the protection tube on the other side end portion thereof is in the range between 100:80 and 100:95, but it is not limited thereto. In more detail, the ratio is in the range between 100:90 and 100:95.

The protection tube is formed of a tapered tube having a smaller inner diameter than the diameter of the section of the coil spring of the car suspension so as to protect the coil spring of the car suspension. In detail, the smaller inner diameter d1 of the protection tube is equal to or smaller than the diameter of the section of the coil spring of the car suspension, but it is not limited thereto. In more detail, the smaller inner diameter d1 of the protection tube is smaller by 0 to 10% than the diameter of the section of the coil spring of the car suspension. After the protection tube is swelled, for example, to allow the inner diameter to be increased by about 30%, it is fitted to the coil spring of the car suspension, so that the smaller inner diameter d1 of the protection tube is smaller than the diameter of the section of the coil spring of the car suspension.

The sectional shape of the protection tube is circular or polygonal, but it is not limited thereto. In more detail, the protection tube has a circular section as shown in the drawings.

The protection tube has a plurality of air holes penetrated up and down on the periphery thereof.

The protection tube is formed of the tapered tube having no incised portion formed thereon, and accordingly, when the protection tube is coated on the coil spring of the car suspension, foreign materials cannot easily enter the gap between the protection tube and the coil spring of the car suspension. As a result, the protection tube is rarely changed in shape or damaged, thus reliably protecting the coil spring of the car suspension.

FIG. 2 is an enlarged view showing the protection tube for a coil spring of a car suspension according to the first embodiment of the present invention. Referring to FIG. 2, the spiral groove is formed on the outer peripheral surface of the protection tube. The formation of the spiral groove on the outer peripheral surface of the protection tube allows the protection tube to be easily released from the mold upon injection molding. Further, when the protection tube is dried after swelled, the drying time can be shortened.

A distance l between the adjacent spiral grooves formed on the outer peripheral surface of the protection tube is in the range of 10 to 30 mm, but it is not limited thereto. In more detail, the distance l is in the range of 13 to 18 mm. If the distance l between the adjacent spiral grooves is within the above-mentioned range, the protection tube can be dried with no damage when shrinks through drying after swelled.

A depth h of the spiral groove formed on the outer peripheral surface of the protection tube is in the range of 0.4 to 1 mm, but it is not limited thereto. In more detail, the depth h is in the range of 0.5 to 0.8 mm. If the depth h of the spiral groove is within the above-mentioned range, the protection tube can be dried rapidly with no damage when shrinks through drying after swelled.

A thickness of the protection tube is in the range of 1 to 5 mm, but it is not limited thereto. In more detail, the thickness is in the range of 1.5 to 3 mm. If the thickness of the protection tube is within the above-mentioned range, the protection tube can sufficiently absorb external shocks to protect the coil spring of the car suspension from the external shocks.

The ratio of the depth of the spiral groove to the thickness of the protection tube is in the range between 0.2:1 and 0.4:1, but it is not limited thereto. In more detail, the ratio is in the range between 0.25:1 and 0.35:1. If the ratio of the depth of the spiral groove to the thickness of the protection tube is within the above-mentioned range, the protection tube can be dried with no damage when shrinks through drying after swelled.

The protection tube is made of synthetic rubber or synthetic resin, but it is not limited thereto. In detail, the protection tube is made of a polyurethane elastomer having high strength, high elasticity, excellent abrasion resistance and excellent impact resistance. In more detail, the protection tube includes one or more selected from the group consisting of polyester resin containing polycaprolactone and polyadipate and polyether resin containing polytetramethylene glycol, polyethylene glycol and polypropylene glycol. In more detail, the protection tube includes a thermoplastic polyurethane elastomer.

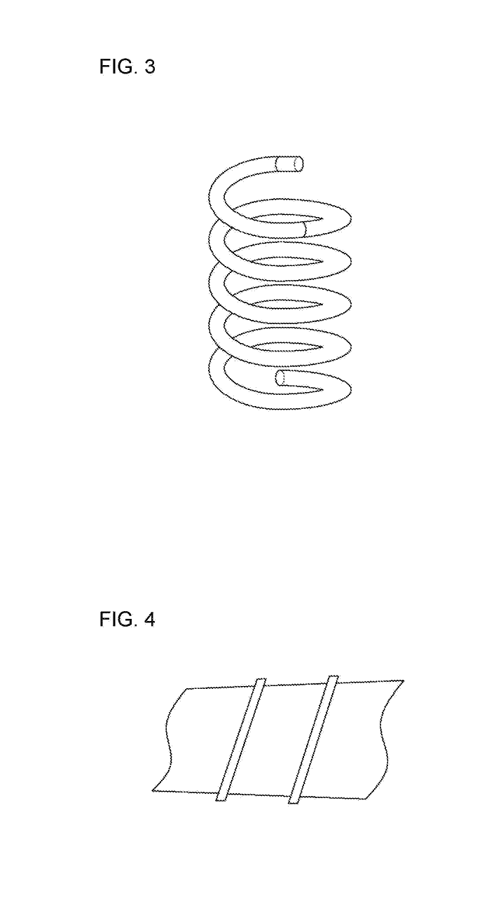

FIG. 3 is a perspective view showing the state wherein the protection tube according to the first embodiment of the present invention is coupled to the coil spring of the car suspension. Referring to FIG. 3, the protection tube is coupled to the top and/or bottom of the coil spring of the car suspension to absorb the shock and/or noise generated from the contraction and/or release caused by the external force applied to the car suspension in upward and downward directions.

FIG. 4 is an enlarged view showing a protection tube for a coil spring of a car suspension according to a second embodiment of the present invention. Instead of the spiral groove, as shown in FIG. 4, the protection tube has a spiral protrusion formed along the outer peripheral surface thereof. The formation of the spiral protrusion enables the durability of the protection tube to be improved. Further, when the car suspension is contracted after the protection tube has been mounted on the coil spring of the car suspension, the contact surface between the protection tubes adjacent to each other can be decreased, thus reducing the noise. Furthermore, the formation of the spiral protrusion along the outer peripheral surface of the protection tube enables the mold to be easily released upon the injection molding of the protection tube.

If the spiral protrusion is formed along the outer peripheral surface of the protection tube, the distance l between the adjacent spiral grooves formed on the outer peripheral surface of the protection tube is the same as the distance between the adjacent spiral protrusions formed on the outer peripheral surface of the protection tube, and the depth h of the spiral groove formed on the outer peripheral surface of the protection tube is the same as the height of the spiral protrusion formed on the outer peripheral surface of the protection tube.

According to the present invention, there is provided a method for manufacturing a coil spring of a car suspension including the steps of: impregnating a protection tube for the coil spring of the car suspension into a composition including 45 to 65 wt % of a swelling promotion solvent, 30 to 54 wt % of a swelling control solvent, and 0 to 5 wt % of a lubricating additive to obtain the swelled protection tube for the coil spring of the car suspension; fitting the swelled protection tube for the coil spring of the car suspension to the coil spring of the car suspension to obtain an assembled body; and drying the assembled body in the air.

The protection tube for a coil spring of a car suspension is first impregnated into the composition including 45 to 65 wt % of the swelling promotion solvent, 30 to 54 wt % of the swelling control solvent, and 0 to 5 wt % of the lubricating additive to obtain the swelled protection tube for the coil spring of the car suspension, but in this case, the composition ratio of the composition is not limited to the above-mentioned ratio. The composition ratio of the composition is appropriately selected in accordance with the kinds and thicknesses of the protection tube.

At this time, the protection tube is impregnated into the composition for 1 to 8 hours, preferably, for 2 to 6 hours, but it is not limited thereto. If the impregnation of the protection tube is conducted within the above-mentioned range, the protection tube can be sufficiently swelled, so that it can be easily fitted to the coil spring of the car suspension, while having appropriate durability with which the swelled protection tube can be handled with no difficulty.

The protection tube is impregnated into the composition and swelled up to a critical swelling rate of 20 to 30%. If the critical swelling rate is deviated from the above-mentioned range, the protection tube may be destructed. In this case, the critical swelling rate is calculated by the following equation.

Wₑ=W₂−W₁/W₁×100,

wherein Wₑ represents a critical swelling rate (%), W₁ an initial weight (g) of protection tube, and W₂ a weight (g) after critical swelling of protection tube.

Further, the protection tube is impregnated into the composition at a temperature in the range of 15 to 30° C., preferably, in the range of 20 to 25° C., but it is not limited thereto. If the impregnation temperature of the protection tube is within the above-mentioned range, the protection tube can be swelled within rapid time, while preventing the deformation in the shape thereof.

In this case, 15 to 18 g of the composition with respect to 10 g of the protection tube is used, but it is not limited thereto. In detail, 16 to 17 g of the composition with respect to 10 g of the protection tube is used. If the composition is used within the above-mentioned range, the protection tube can be sufficiently swelled in the composition.

Next, the swelled protection tube for the coil spring of the car suspension is fitted to the coil spring of the car suspension to obtain an assembled body. At this time, desirably, the end of the swelled protection tube having the smaller inner diameter is close to the portion adjacent to a top and/or bottom spring assembly of the coil spring of the car suspension. The inner diameter on one side of the protection tube is smaller than that on the other side thereof, so that the protection tube can be fixed to a desired position when dries and shrinks after fitted to the coil spring of the car suspension. That is, if the swelled protection tube is fitted to the coil spring around one side having the smaller inner diameter, the protection tube is fixed to the desired position after dried.

Since the protection tube is swelled, the diameter of the swelled protection tube is larger than that of the coil spring of the car suspension. Accordingly, even if the incised portion is not formed on the protection tube, the swelled protection tube can be easily fitted to the coil spring of the car suspension.

Finally, the assembled body is dried in the air. The method for drying the assembled body is not limited specially, but for example, the assembled body may be dried by means of natural drying, hot air drying, or cool air drying. So as to shorten the dry time, particularly, the assembled body is dried with hot air or cool air.

At this time, the assembled body is dried for 1 to 4 hours, preferably, for 60 to 120 minutes, but it is not limited thereto.

The assembled body is dried at a temperature in the range of 15 to 30° C., preferably, in the range of 20 to 25° C., but it is not limited thereto. If the dry temperature is within the above-mentioned range, the swelled protection tube can shrink within rapid time, while preventing the deformation in the shape thereof.

The swelling promotion solvent includes one or more selected from the group consisting of acetone, tetrahydrofuran, chloroform, ethyl chloride, trichloroethylene, tetrachloroethylene, methyl chloride, mehylene chloride, dichloroethane, chlorobenzene, benzene, toluene, methyl acrylate, vinyl acetate, ethyl acetate, di acetone alcohol, dibutyl phthalate, methylethylketone, ethylhexanol and methyl acetate, but it is not limited thereto. More preferably, the swelling promotion solvent includes one or more selected from the group consisting of tetrahydrofuran, chloroform, methyl chloride, methylene chloride, methyl acetate and chlorobenzene. Most preferably, the swelling promotion solvent includes methyl chloride.

The swelling promotion solvent has solubility in the range between 18 and 20.1 Mpₐ^{1/2}, but it is not limited thereto. If the swelling promotion solvent has the solubility within the above-mentioned range, it is advantageous to adjust the critical swelling rate of the protection tube to 20 to 30%.

The swelling control solvent includes one or more selected from the group consisting of nucleic acid, heptane, octane, cyclohexane, isopropyl alcohol, methanol and distilled water, but it is not limited thereto. More preferably, the swelling control solvent includes methanol.

The lubricating additive includes one or more selected from the group consisting of solid paraffin, liquid paraffin, ethylene glycol, propylene glycol, silicone oil and soybean oil, but it is not limited thereto. More preferably, the lubricating additive includes liquid paraffin,

The composition includes the swelling promotion solvent as well as the swelling control solvent having a relatively low swelling tendency, thus controlling the degree of swelling of the polyurethane tube and the time required to reach a given degree of swelling. Further, the composition includes the lubricating additive, thus gently fitting the swelled protection tube to the coil spring of the car suspension.

Preferably, the composition includes methylene chloride, methanol and liquid paraffin. More preferably, the composition includes 45 to 65 wt % of methylene chloride, 30 to 54 wt % of methanol and 0 to 5 wt % of liquid paraffin. Most preferably, the composition includes 50 to 60 wt % of methylene chloride, 44 to 50 wt % of methanol and 0 to 0.5 wt % of liquid paraffin.

Accordingly, the protection tube for the coil spring of the car suspension according to the present invention is tapered wherein the inner diameter d2 of the protection tube on one side end portion thereof is larger than the inner diameter d1 of the protection tube on the other side end portion thereof, and the protection tube has the spiral groove formed along the outer peripheral surface thereof.

The protection tube is formed of the tapered tube having a smaller inner diameter than the diameter of the section of the coil spring of the car suspension so as to protect the coil spring of the car suspension. In detail, the smaller inner diameter d1 of the protection tube is equal to or smaller than the diameter of the section of the coil spring of the car suspension, but it is not limited thereto. In more detail, the smaller inner diameter d1 of the protection tube is smaller by 0 to 10% than the diameter of the section of the coil spring of the car suspension. After the protection tube is swollen, for example, to allow the inner diameter to be increased by about 30%, it is fitted to the coil spring of the car suspension, so that the smaller inner diameter d1 of the protection tube is smaller than the diameter of the section of the coil spring of the car suspension.

The sectional shape of the protection tube is circular or polygonal, which is not limited thereto. In more detail, the protection tube has the circular section as shown in the drawings.

The protection tube is formed of the tapered tube having no incised portions formed thereon, and accordingly, when the protection tube is coated on the coil spring of the car suspension, foreign materials cannot easily enter the gap between the protection tube and the coil spring of the car suspension. As a result, the protection tube is rarely changed in shape or damaged, thus reliably protecting the coil spring of the car suspension.

A distance l between the adjacent spiral grooves formed on the outer peripheral surface of the protection tube is in the range of 10 to 30 mm, but it is not limited thereto. In more detail, the distance l is in the range of 13 to 18 mm. If the distance l between the adjacent spiral grooves is within the above-mentioned range, the protection tube can be dried with no damage when shrinks through drying after swollen.

A depth h of the spiral groove formed on the outer peripheral surface of the protection tube is in the range of 0.4 to 1 mm, but it is not limited thereto. In more detail, the depth h is in the range of 0.5 to 0.8 mm. If the depth h of the spiral groove is within the above-mentioned range, the protection tube can be dried rapidly with no damage when shrinks through drying after swollen.

A thickness of the protection tube is in the range of 1 to 5 mm, but it is not limited thereto. In more detail, the thickness is in the range of 1.5 to 3 mm. If the thickness of the protection tube is within the above-mentioned range, the protection tube can sufficiently absorb external impacts to protect the coil spring of the car suspension from the external impacts.

The ratio of the depth of the spiral groove to the thickness of the protection tube is in the range between 0.2:1 and 0.4:1, but it is not limited thereto. In more detail, the ratio is in the range between 0.25:1 and 0.35:1. If the ratio of the depth of the spiral groove to the thickness of the protection tube is within the above-mentioned range, the protection tube can be dried with no damage when shrinks through drying after swollen.

The protection tube is made of synthetic rubber or synthetic resin, but it is not limited thereto. In more detail, the protection tube is made of a polyurethane elastomer having high strength, high elasticity, excellent abrasion resistance and excellent impact resistance. In more detail, the protection tube is made of one or more resins selected from the group consisting of polyester resin containing polycaprolactone and polyadipate and polyether resin containing polytetramethylene glycol, polyethylene glycol, and polypropylene glycol. In more detail, the protection tube is made of a thermoplastic polyurethane elastomer.

FIG. 3 is a perspective view showing the state wherein the protection tube according to the first embodiment of the present invention is coupled to the coil spring of the car suspension. Referring to FIG. 3, the protection tube is coupled to the top and/or bottom of the coil spring of the car suspension to absorb the impact and/or noise generated from the contraction and/or release caused by the external force applied to the car suspension in upward and downward directions.

### Example 1

### Method for Manufacturing the Protection Tube for the Coil Spring of the Car Suspension

Pallet type thermoplastic polyurethane (having hardness of 90 to 95 shore A and trade name IP091A made by Dongah Chemical Co., Ltd.) was fed to a hopper of an injection molding machine (Woojin 350 ton) on which a mold capable of injection molding a tapered tube having a spiral protrusion formed on the outer peripheral surface thereof is mounted. Next, a screw was moved at an injection molding pressure of 50 kg/cm² and an injection molding speed of 20 cm³/sec at a temperature of about 150° C. for about 2 minutes. Finally, the tapered polyester tube was produced.

### Example 2

### Method for Manufacturing the Coil Spring of the Car Suspension

The polyurethane protection tube for the coil spring of the car suspension produced in Example 1 was impregnated into the composition including 55 wt % of m ethylene chloride, 47.7 wt % of methanol and 0.03 wt % of liquid paraffin for about 4 hours and swelled thereinto. The swelled protection tube was fitted to the coil spring (from Sammok spring Co., Ltd) of the car suspension. Finally, the coil spring of the car suspension to which the protection tube was fitted was dried in the air for one hour, thus producing the coil spring of the car suspension to which the protection tube is fitted.

As described above, the protection tube for the coil spring of the car suspension according to the present invention is tapered so that unlike the existing protection tube for the coil spring of the car suspension having the incised portion formed thereon, it can prevent the invasion of foreign materials into the incised portion, thus improving the durability and conducting easy molding and mounting.

Additionally, the method for manufacturing the coil spring of the car suspension according to the present invention can be carried out in a simple manner, thus reducing the manufacturing cost.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A protection tube for a coil spring of a car suspension, the protection tube being tapered wherein the inner diameter of the protection tube on one side end portion thereof is larger than the inner diameter of the protection tube on the other side end portion thereof, the protection tube has a spiral groove or protrusion formed along the outer peripheral surface thereof, the protection tube comprises one or more selected from the group consisting of polyester resin containing polycaprolactone and polyadipate and polyether resin containing polytetramethylene glycol, polyethylene glycol and polypropylene glycol, a distance between the adjacent spiral grooves or protrusions is in the range of 10 to 30 mm, a depth of the spiral groove or a height of the spiral protrusion is in the range of 0.4 to 1 mm, and the ratio of the depth of the spiral groove or the height of the spiral protrusion to the thickness of the protection tube is in the range between 0.2:1 and 0.4:1.

2. A method for manufacturing a coil spring of a car suspension, the method comprising the steps of:
impregnating a protection tube for a coil spring of a car suspension into a composition comprising 45 to 65 wt % of a swelling promotion solvent, 30 to 54 wt % of a swelling control solvent, and 0 to 5 wt % of a lubricating additive to obtain the swelled protection tube for the coil spring of the car suspension;
fitting the swelled protection tube for the coil spring of the car suspension to the coil spring of the car suspension to obtain an assembled body; and
drying the assembled body in the air,
wherein the inner diameter of the protection tube on one side end portion thereof is larger than the inner diameter of the protection tube on the other side end portion thereof, the protection tube has a spiral groove or protrusion formed along the outer peripheral surface thereof, the protection tube comprises one or more selected from the group consisting of polyester resin containing polycaprolactone and polyadipate and polyether resin containing polytetramethylene glycol, polyethylene glycol and polypropylene glycol, a distance between the adjacent spiral grooves or protrusions is in the range of 10 to 30 mm, a depth of the spiral groove or a height of the spiral protrusion is in the range of 0.4 to 1 mm, and the ratio of the depth of the spiral groove or the height of the spiral protrusion to the thickness of the protection tube is in the range between 0.2:1 and 0.4:1.

3. The method according to claim 2, wherein the swelling promotion solvent comprises one or more selected from the group consisting of acetone, tetrahydrofuran, chloroform, ethyl chloride, trichloroethylene, tetrachloroethylene, methyl chloride, methylene chloride, dichloroethane, chlorobenzene, benzene, toluene, methyl acrylate, vinyl acetate, ethyl acetate, di acetone alcohol, dibutyl phthalate, methylethylketone, ethylhexanol and methyl acetate.

4. The method according to claim 2, wherein the swelling control solvent comprises one or more selected from the group consisting of nucleic acid, heptane, octane, cyclohexane, isopropyl alcohol, methanol and distilled water.

5. The method according to claim 2, wherein the lubricating additive comprises one or more selected from the group consisting of solid paraffin, liquid paraffin, ethylene glycol, propylene glycol, silicone oil and soybean oil.

6. The coil spring of a car suspension manufactured using the method according to claim 2.
